(19) United States
(12) Patent Application Publication
(10) Pub. No.: US 2015/0258716 A1
(43) Pub. Date: Sep. 17, 2015

(54) METHOD FOR PRODUCING A DECORATED WALL OR FLOOR PANEL

(71) Applicant: AKZENTA PANEELE + PROFILE GMBH, Kaisersesch (DE)

(72) Inventor: Hans-Jürgen Hanning, Bergisch Gladbach (DE)

(73) Assignee: AKZENTA PANEELE + PROFILE GMBH, Kaisersesch (DE)

(21) Appl. No.: 14/439,995

(22) PCT Filed: Oct. 23, 2013
(86) PCT No.: PCT/EP2013/072199

§ 371 Date: Apr. 30, 2015

(30) Foreign Application Priority Data
Nov. 7, 2012 (EP) 12191678.7

(51) Int. Cl. B29C 33/38; B23K 26/38; B29C 59/04

(52) U.S. Cl. CPC B29C 33/3835; B29C 59/046; B29C 33/3842; B23K 26/38

(57) ABSTRACT

A method for producing a decorated wall or floor panel comprising applying a decor imitating a decorative template onto at least a portion of a plate-shaped carrier; and applying a top layer onto at least a portion of the decor, characterized in that the top layer is provided with a template identical structure by use of an embossing surface which is formed on the basis of provided three-dimensional decor data.

### REFERENCE TO RELATED APPLICATIONS

This application is a U.S. national stage application of International Patent Application No. PCT/EP2013/072199, filed Oct. 23, 2013, and claims the benefit of priority of European Application No. 12191678.7, filed Nov. 7, 2012, the entire disclosures of which are incorporated herein by reference.

### FIELD OF THE INVENTION

The present invention relates to a method for producing a decorated wall or floor panel and a device for producing such a wall or floor panel.

### BACKGROUND OF THE INVENTION

Such decorated panels are known per se, wherein the term wall panel also includes panels which are suitable as a ceiling lining. They normally consist of a carrier or a core of a solid material such as a wood-based material, which on at least one side is provided with a decorative layer and a top layer and optionally with further layers, for example, a wearing layer disposed between the decorative and the top layer. The decorative layer is usually a printed paper which is impregnated with an aminoplast resin. The top layer and the remaining layers are usually made of an aminoplast resin, too.

From the document U.S. Pat. No. 6,888,147 B1 a process for producing a panel is known. In a method known from this document, a decor is applied onto a core, whereupon the decor is provided with a varnish layer. In order to achieve a structure of the surface the top varnish layer is only partially applied, for example on the basis of data obtained e.g. by a digital camera.

However, in certain application areas, and in particular if highly detailed decorative panels are required previously known panels possibly show an unsatisfactory decoration, in particular when the imitation of a natural material such as wood or natural stone is desired.

### SUMMARY OF THE INVENTION

Thus, it is an object of the present invention to provide an improved method for producing decorated wall or floor panels.

This object is achieved by a method comprising providing a plate-shaped carrier, applying a decor imitating a decorative template onto at least a portion of the plate-shaped carrier, and applying a top layer onto at least a portion of the decor, wherein the top layer is provided with a template identical structure simulating the applied decor by embossing with an embossing surface which is formed on the basis of provided three-dimensional decor data. With respect to a panel embossing device the object is achieved by a panel embossing device comprising a feeder for a plate-shaped carrier to be embossed, wherein the plate-shaped carrier comprises a decor and a top layer applied onto the decor; and an embossing surface for embossing a structure imitating a decorative template into the top layer, wherein the embossing surface is formed template identical on the basis of provided three-dimensional decor data.

Thus, the invention proposes a process for producing a decorated wall or floor panel comprising the steps of:
a) providing a plate-shaped carrier,
b) applying a decor simulating a decorative template onto at least a portion of the carrier, and
c) applying a top layer on at least a portion of the decor, the method being characterized in that the top layer is provided with a template identical structure by use of an embossing means, the embossing surface of which is formed on the basis of provided three-dimensional decor data.

### BRIEF DESCRIPTION OF THE FIGURES

FIG. 1 shows schematically a cross sectional side view of a wall or floor panel produced according to a method according to the invention; and

FIG. 2 shows schematically a panel embossing device for implementing the method according to the invention.

### DETAILED DESCRIPTION OF PREFERRED EMBODIMENTS

It could be shown that by providing the top layer with a template identical structure by use of an embossing means the embossing surface of which is formed on the basis of provided three-dimensional decor data the disadvantages known from the prior art in terms of accuracy and details of an imitation of the applied decor can be overcome.

The term “decorative wall or floor panel” or “decorative panel” in the sense of the invention in particular means wall, ceiling or floor panels comprising a decor applied onto a carrier plate. Decorative panels are used in a variety of ways both in the field of interior design of rooms and for decorative cladding of buildings, for example in exhibition stand construction. One of the most common uses of decorative panels is their use as a floor covering. Herein, the decorative panels often comprise a decor intended to replicate a natural material.

Examples of such replicated natural materials are wood species such as maple, oak, birch, cherry, ash, walnut, chestnut, wenge or even exotic woods such as Panga Panga, mahogany, bamboo and bubinga. In addition, often natural materials such as stone surfaces or ceramic surfaces are replicated.

Accordingly, a “decorative template” in the sense of the present invention in particular means such an original natural material or at least a surface of such a material which is to be imitated or replicated by the decor.

The term “three-dimensional decor data” in the sense of the present invention in particular means electronic data, which represent the decorative template based on its three-dimensional size, colour, structure, etc. and thus allow a complete physical or spatial haptically and visually identical or at least substantially identical reproduction of the decorative template. The three-dimensional decor data can be determined or generated directly or synthetically from the decorative template and thus, for example, can be stored in a database for later access. Moreover, the three-dimensional decor data in particular can have a resolution which does not enable a human to recognize a difference with respect to the decorative template in particular by an optical or haptic comparison or only enables to recognize a difference to a desired limited extent.

The term “template identical” in the sense of the present invention means a highly detailed simulation or imitation of the decorative template by the applied decor. Here, an imitation in each spatial direction or three-dimensionally can be realised, wherein, however, minor deviations due to technical feasibility, such as deviations from the provided decor data or the decorative template should be covered by the term template identical. Moreover, in the sense of the present invention the term template identical should include not only a positive representation of the decorative template with respect to the colour and/or structure, but also a corresponding negative representation.

Herein, the term “plate-shaped carrier” in the sense of the present invention can be understood as a natural product, such as a wood-based material, a fiber material or a material comprising plastics that is formed in the shape of a plate and, thus, in particular can serve as a core or as a base layer of the panel to be manufactured. For example, the plate-shaped carrier can already impart or contribute to a suitable stability for the panel. The plate-shaped carrier can already define the shape and/or size of the panel to be produced. However, the plate-shaped carrier can also be provided as a large plate. A large plate in the sense of the invention in particular is a carrier whose dimensions several times exceed the dimensions of the final decorative panels, and which is cut during the course of the manufacturing process into a corresponding plurality of decorative panels, for example by sawing, laser or water jet cutting.

Wood-based materials in the sense of the invention in addition to solid wood materials are materials such as cross-laminated timber, glue-laminated timber, blockboard, veneered plywood, laminated veneer lumber, parallel strand lumber and bending plywood. In addition, wood-based materials in the sense of the invention are also chipboards such as pressboards, extruded boards, oriented structural boards (OSB) and laminated strand lumber as well as wood fiber materials such as wood fiber insulation boards (HFD), medium hard and hard fiberboards (MB, HFH) and in particular medium density fiberboards (MDF) and high density fiberboards (HDF). Even modern wood-based materials such as wood polymer materials (wood plastic composite, WPC), sandwich boards made of a lightweight core material such as foam, rigid foam or honeycomb paper and a layer of wood applied thereto, and minerally hardened, for example with cement, chipboards are wood-based materials in the sense of the invention. Moreover, cork represents a wood-based material in the sense of the invention.

In the sense of the invention the term fiber materials means materials such as paper and non-woven fabrics on the basis of plant, animal, mineral or even synthetic fibers as well as cardboards. Examples are fiber materials on the basis of plant fibers and, in addition to papers and non-woven fabrics made of cellulose fibers, boards made of biomass such as straw, maize straw, bamboo, leaves, algae extracts, hemp, cotton or oil palm fibers. Examples of animal fiber materials are keratin-based materials such as wool or horsehair. Examples of mineral fiber materials are mineral wool or glass wool.

Examples of thermoplastic plastic materials are polyvinyl chloride, polyolefines (such as polyethylene (PE), polypropylene (PP)), polyamide (PA), polyurethane (PU), polystyrene (PS), acrylonitril butadiene styrene (ABS), polymethyl methacrylate (PMMA), polycarbonate (PC), polyethylene terephthalate (PET), polyether ether ketone (PEEK) or mixtures or co-polymerizates thereof. The plastic materials can include common fillers, such as calcium carbonate (chalk), aluminum oxide, silicagel, quartz powder, wood flour, gypsum. In addition they can be coloured in a known way. In particular it can be provided that the carrier material comprises a flame inhibitor.

By means of the above-described method it is possible to imitate or simulate a decorative template in a particularly detailed and highly accurate manner in a three-dimensional shape. This is not only possible by imitating the two-dimensional shape of a pore or the like of a wood material, for example, with a uniform depth. Rather, also a different depth in the pore itself or a depth distribution of the pore is possible, so that in a three-dimensional manner not only a template-like but rather a template identical replica of the decorative template is possible by the decor. In other words, pores or other structural features of the decorative template can be imitated accurately and realistically not only with respect to their width or length but also with respect to their depth or depth distribution at different depths in a pore.

In order to enable such a template identical replica of a decorative template in a method described above a decorative layer applied to the decor is provided with a template identical structure. This is realised by use of an embossing means such as with the aid of pressure and elevated temperature, wherein the embossing means is formed or structured on the basis of provided three-dimensional data. In detail, the embossing means, such as a stamping die, comprises an embossing surface, that is, a surface which contacts the element to be embossed during the embossing process which is structured template identical.

In the method at first the decor is applied to the plate-shaped carrier. This can, for example, be realized in a conventional manner such as by attaching a layer, such as a layer made of paper, provided with a decor onto the carrier. In this phase, the product thus produced can already be stored for later use or immediately used further. In a further process step a top layer is applied onto the decor, as will be explained below. A top layer in the sense of the present invention means in particular a layer which is arranged on the decor and covers it at least partially, in particular completely. The top layer produced by such a process can substantially have two functionalities in such a panel. Firstly, the top layer can serve as a layer applied as an outer border which in particular protects the decorative layer from wear or damage caused by dirt, moisture or mechanical effects such as abrasion. In addition, the top layer in accordance with the method described above has the further function of receiving a structure or to impart a haptic impression identical to the decorative template to the panel, more precisely to its surface.

For this purpose, an embossing means is used, which embosses a corresponding structure into the top layer. This can be realized in dependence of the material used for the top layer, for example, under pressure and optionally under elevated temperature. Herein, the embossing means depending on the desired structure to be produced can be a negative or a positive of the structure to be introduced and obtains its shape in particular by molding based on the three-dimensional decor data. Thus, on the basis of such decor data a positive or negative image or such a structure of the decorative template can be produced in the embossing means or on its embossing surface, because these data identically describe the decorative template and thus enable a positive or negative structure of the panel to be produced if used for forming the embossing means.

Thus, by means of the above-described method in addition to a positive image with respect to the colour and/or structure also a corresponding negative image of the decorative template is possible. In detail, as is known, for example, from positive staining or negative staining of wood-based materials, the colour impression for example of a structure can be inverted, so that with respect to the colour and in particular with respect to lighter and darker areas a negative is created. A similar effect, in addition to the colour impression, is possible for the applied structure or the structure embossed into the top layer, too, so that also with respect to the structural design in addition to a positive a negative can be realized by use of digital data. Such effects, too, can be integrated into a manufacturing process based on digital three-dimensional data without any problems and without lead-time or retrofitting.

Herein, as described below, an adaptation to the embossing means used or to the structure introduced by the embossing means can be realised with respect to the material of the top layer or at least the structure-receiving region of the top layer, such as a structural layer. In particular, the material as such or the preparation of the material with respect to the embossing means or to the structure introduced by the embossing means can be selected. Herein, in particular the properties important for the shaping such as moldability, flow properties, etc. can be selected accordingly. Thus, an adaptation can be made in particular with respect to the height, width, depth and pattern of the introduced structures so that they remain stable even after an embossing process and do not degrade, for example in shape prior to curing of the top layer. This, for example, can be implemented by specifically influencing the flow properties via partial curing, the material composition used or similar measures.

In particular through the use of digital decor data a highly accurate forming of the decor and thus a highly accurate perceptional impression of the panel produced is possible. By the provision of digital decor data structures with an extremely high resolution and thus highly detailed can be imitated. Moreover, the use of digital decor data allows to respond in a particularly simple, inexpensive and dynamically way to changing customer requirements, since only new or changed decor data have to be provided on the basis of which again a highly accurate imitating product can be produced.

Further, by means of the above-described method in a particularly advantageous manner a so-called heliochrome effect can be realized. This term in the sense of the present invention means in particular that the decor comprises areas of different gloss levels such as both matte and glossy areas which in particular can be disposed in different depths of surface structures. As a result an even more realistic image of the decorative template can be realized.

Further, the embossing means can be recycled in a simple manner before and/or after one or a plurality of embossing steps, for example by removing the structure of the surface and subsequently introducing a new structure into the surface of the embossing means based on digital three-dimensional data. This allows also in a very simple way to change the produced structure without having to perform complex retrofittings.

Thus, from the foregoing it is apparent that by means of the above-described method compared to the prior art an improved reproduction of the decorative template and thus a highly detailed product is possible.

According to one embodiment an embossing roller can be used as an embossing means. On the one side a structure can be introduced into an embossing roller in a suitable way in order to transfer it to the top layer or to emboss it into the top layer. In addition, an embossing roller or an embossing calender is particularly suitable for a continuous process, which makes the above-described method applicable in a particularly cost-efficient way for large-scale applications. Furthermore, with embossing rollers as embossing means a well-defined pressure applied onto the top layer can be adjusted in an appropriate way, such that due to particularly defined conditions a particularly defined result identical to the decorative template can be achieved. Herein, the circumference of the embossing roller can be greater than or equal to the length of the panel to be produced in order to produce a desired structure at each location of the panel.

According to a further embodiment the embossing surface can be formed by use of electromagnetic radiation or the embossing means can be provided in particular on its surface with a positive or negative of the structure of the decorative template. For example, the embossing means may be formed by use of a laser. Through the use of electromagnetic radiation such as a laser the structure of the embossing means can be introduced as a negative or positive of the decorative template very precisely and also with the highest resolution, so that the top layer to be embossed, too, is a very accurate and detailed image of the decorative template. In addition, in particular methods which are based on electromagnetic waves or electromagnetic radiation can be provided in a particular simple way with digital three-dimensional data and be executed such that the method according to this embodiment may be implemented in a particularly simple way. Furthermore, such methods for forming the embossing means are substantially implemented directly on the basis of the input digital data. Thus, the method of this embodiment is particularly flexible and adaptations to customer requirements with respect to the panel to be produced can be made in a simple way.

According to a further embodiment the embossing means may include at least on its embossing surface a plastic material which is formed by laser structuring with subsequent electroplating. Such a process is implemented in a manner known per se from electroplating of plastic. In detail, first the surface of the plastic material can be roughened e.g. by use of a suitable laser beam, such as to form a defined structure roughened with caverns or adhesive positions, into which electrically conductive particles such as palladium, may be incorporated. The structure can be generated as described above on the basis of three-dimensional decor data. By means of the metallic particles a metal layer can be applied in a further step, for example by electroless metallization, which adheres well due to the roughening. Alternatively, in order to produce the desired structure, the entire surface area can be coated with a conductive layer, and then the conductive layer, such as a metallization, can be removed selectively by means of a laser, in order to form isolation regions or areas of good electrical conductivity. On this basis layer or particularly on the metallic regions in a further step the desired surface metallization can be applied by electroplating. Thus, the surface of the embossing means or its embossing surface can comprise a hard metallic structure or a structure with specific properties, such that die resulting structure in the top layer can be selectively influenced. In this way, for example, defined degrees of gloss can be introduced. In addition, the embossing surface can thus be at least locally very hard and wear resistant and very durable.

According to a further embodiment the top layer can be applied in multiple layers. For example, the top layer can have a structural layer and a protective layer. In this embodiment in a particularly advantageous manner the various properties or requirements of the top layer can be realized while it is not necessary to potentially make any compromises because of respective other requirements. In detail, a first layer can for example form a structural layer and be applied directly onto the decor. This layer can be applied, for example, as a viscous mass and thus have a good deformability, in particular plastically. In this state the structure then can be embossed by the embossing means. After embossing the structure the material of the structural layer can, for example, be hardened and thus have a sufficient stability for the structure. A further layer, which is applied onto the structural layer and in particular is formed after the embossing process may be referred to in the following as a protective layer and as a primary object can serve the protection of the panel. Thus, in selecting the material of this layer no attention needs to be paid on a good moldability, rather the material can be selected, for example, such that it is distributed in a uniform thickness on the structured structural layer so as not to distort the template identical structure. In addition, the material of the protective layer, for example, can cure and, moreover, in particular can be selected such that it can provide a good protection for the structured layer, such as a good abrasion resistance. Thus, in this embodiment a particularly template identical and moreover particularly stable panel can be produced.

Furthermore, a multi-layer structure advantageously can serve in particular to produce a particularly cost-effective top layer. For this purpose, for example, an outer top sublayer made of a varnish, such as a curable acrylic varnish, may be formed, whereas the top layer may comprise a basis sublayer which is formed from a less expensive material and, for example, is formed from a duroplast such as a melamine or a melamine resin. Herein, the top sublayer as well as the entire top layer may be advantageously formed with respect to the haptic to the desired requirements. Here, for example, without limitation, the basis sublayer may correspond to the structural layer, whereas the top sublayer may correspond to the protective layer. Furthermore, the top sublayer itself can have a multi-layer structure, too, or can be applied as a multi-layer system. In particular, a plurality of, for example, varnish layers, in particular acrylic varnish layers can be applied. Herein a multi-layer construction of the top sublayer can advantageously be implemented such that a structure already produced by the embossing means is not or not significantly altered.

According to another embodiment the top layer can be at least partially formed from a radiation curable composition. Herein, the compositions can be applied by a hot or cold process. For example, a radiation-curable varnish can be used. Herein, it may be provided that the wearing layer includes hard materials such as titanium nitride, titanium carbide, silicon nitride, silicon carbide, boron carbide, tungsten carbide, tantalum carbide, alumina (corundum), zirconia or mixtures thereof, in order to increase the wear resistance of the layer. Herein, the hard material can be included in the wearing layer composition in an amount between 5 wt.-% and 40 wt.-%, preferably between 15 wt.-% and 25 wt.-%. Herein, the hard material preferably has a mean grain diameter between 10 μm and 250 μm, more preferably between 10 μm and 100 μm. In this way in a preferable way it is achieved that the wearing layer composition forms a stable dispersion and a decomposition or precipitation of the hard material within the wearing layer composition can be avoided. For forming a corresponding wearing layer in one embodiment of the invention it may be provided that the radiation curable composition including the hard material is applied at a concentration between 10 g/m² and 250 g/m², preferably between 25 g/m² and 100 g/m². Thereby, the application can be implemented, for example, by means of rollers such as rubber rollers, or by means of pouring devices.

For example, it may be provided that the hard material is not included within the composition at the time of application of the wearing layer composition, but is scattered in the form of particles onto the applied wearing layer composition and subsequently the wearing layer is cured radiation induced.

Further, it may be provided that an irradiation by a radiation inducing the curing process is implemented only to the extent that only a partial curing of the top layer or a structural layer to be formed is achieved. In the thus partially cured layer by means of a suitable embossing means a desired surface structure can be embossed. Subsequently to the formation of the desired pattern in the partially cured top layer a further curing process of the now structured top layer is implemented in particular by further irradiation of the layer or the structural layer with electromagnetic radiation or electron beam radiation. Subsequently optionally a protective layer can be applied.

In particular, the top layer may comprise an acrylic varnish. For example, such a varnish can be used as a protective layer or as the only layer of the top layer or more preferably as a structural layer. In particular, acrylic varnishes can on the one side exhibit a good plastic deformability by being applied onto the carrier or the decor in a suitable consistency or viscosity. Subsequently acrylic varnishes can particularly advantageous be solidified radiation-curable, such that, moreover, also a particularly good strength both of any structural layer and a protective layer can be achieved. Additionally or alternatively a melamine varnish or melamine resin can be used in a single top layer, in a structural layer, a basis layer, or preferably in a protective layer.

According to a further embodiment, a mark can be introduced into the decor, on the basis of which the embossing means can be aligned relative to the decor. For example, the mark can be disposed at an edge region of the decor. In this embodiment in a particularly simple and accurate manner a surface structure matching with the decor image can be produced with high precision. A surface structure matching with the decor image means that the surface of the decorative panel has a haptically perceivable structure which with respect to its shape and pattern corresponds to the applied decor in order to achieve a reproduction of a natural material as close to the original as possible even with respect to the haptic. For example, in this way a synchronous pore can be achieved. Herein, a synchronous pore can in particular be a pore or another structure, which is spatially located exactly there where it is displayed optically by a haptic structure matching with the optical decor features. Herein an alignment of the embossing means with respect to the decor means an active alignment of the decor with respect to the embossing means as well as an active alignment of the embossing means with respect to the decor, wherein an active alignment, for example, can mean a corresponding high-precision displacement of the corresponding component.

According to a further embodiment of the method the three-dimensional decor data can be provided by three-dimensional scanning of the decorative template. In particular, the three-dimensional decor data can be provided by three-dimensional scanning the decorative template by electromagnetic radiation, for example, by a three-dimensional scanner (3D scanner). By means of such a method for providing the three-dimensional decor data the decorative template can be immediately used at any time to provide the corresponding data and to produce a panel. This may be particularly advantageous for a fast and dynamical switching of the production. In addition, the decor data can also be obtained three-dimensionally, i.e. in each spatial direction, with a particularly high resolution of 1000 dpi, for example, or even better and be used for producing the panel. Thus, particularly high-quality details are possible, which allow for a particularly high-precision optical and haptic imitation of the decorative template even three-dimensionally. Herein, the three-dimensional data can also be generated without damaging the template, so that it is basically suitable for an unlimited number of scans and thereby can provide unadulterated data.

According to a further embodiment of the method the decor can be applied by direct printing or laminating. The term “direct printing” in the sense of the invention means the application of a decor directly onto the carrier of a panel or onto an unprinted fiber material layer applied to the carrier. In contrast to the conventional methods in which a decorative layer previously printed with a desired decor is applied onto the carrier, in direct printing the decor is printed directly in the course of the panel manufacturing process. Here, different printing techniques such as flexographic printing, offset printing or screen printing may be used. In particular digital printing techniques such as inkjet processes or laser printing can be used. The abovementioned printing techniques are particularly sophisticated and in particular advantageously suited for a panel production in order to apply a detailed decor. Herein, in the sense of the invention direct printing also includes the application of the decor by means of printing techniques onto a printable layer previously applied onto the carrier. Such a printable layer can e.g. be formed by a liquidly applied and subsequently cured primer layer, for example, of polyethylene, polyacrylate, polypropylene or a previously applied printable foil, paper or non-woven fabric layer.

Herein, the decor may be formed from a particular radiation curable paint and/or ink. Hereby, in particular a fast solidification can be achieved, such that the top layer can be quickly applied onto the decor and the entire process can be carried out within a shorter time period and, thus, cost-efficiently. The term radiation curable paint in the sense of the invention means a composition containing a binder and/or a filler as well as colour pigments and which induced by electromagnetic radiation of a suitable wavelength, such as UV radiation or electron beams, can be at least partially polymerized. The term radiation curable ink in the sense of the invention means a composition essentially free of fillers and comprising colour pigments, which induced by electromagnetic radiation of a suitable wavelength, such as UV radiation or electron beams, can be at least partially polymerized.

In addition, the application of the decoration can be realised by laminating, in particular by dry laminating. In laminating a decor which may be a printed sheet, a printed paper or the like, is applied onto the carrier by use of a laminating agent, such as an adhesive or a varnish. Herein, for the exemplary case of dry laminating a dry adhesive can be used. Furthermore, for an appropriate bonding the influence of an elevated temperature and/or pressure can be helpful to achieve a stable connection between the decor and the plate-shaped carrier.

According to a further embodiment of the method the decor can be applied onto at least a portion of a primer previously applied onto the carrier. This embodiment can be advantageous in particular in direct printing of the decor. Herein, as a primer a liquid radiation curable mixture based on a urethane or urethane acrylate, optionally with one or more of a photoinitiator, a reactive diluent, a UV stabilizer, a rheological agent such as a thickener, radical scavengers, leveling agents, antifoams or preservatives, pigment, and/or a dye can be used. For example, the urethane acrylate may be included in the primer composition in the form of reactive oligomers or prepolymers. The term “reactive oligomer” or “prepolymer” in the sense of the invention is a compound comprising urethane acrylate units which are able to react radiation induced, optionally with addition of a reactive binder or a reactive diluent, into urethane polymer or urethane acrylate polymer. Herein, urethane acrylates in the sense of the invention are compounds which substantially are composed of one or more aliphatic structural elements and urethane groups. Aliphatic structural elements comprise both alkylene groups, preferably comprising 4 to 10 carbon (C) atoms and cycloalkylene groups preferably comprising 6 to 20 carbon atoms. Both the alkylene and the cycloalkylene groups may be mono- or polysubstituted with C₁-C₄ alkyl, in particular methyl and include one or more non-adjacent oxygen atoms. The aliphatic structural elements are optionally linked to each other via quaternary or tertiary carbon atoms, via urea groups, biuret, uretdione, allophanate, cyanurate, urethane, ester or amide groups or via ether oxygen or amine nitrogen. Furthermore, urethane acrylates in the sense of the invention can also include ethylenically unsaturated structural elements. These preferably include vinyl or allyl groups, which may be substituted with C₁-C₄ alkyl, in particular methyl and which, in particular, are derived from α,β-ethylenically unsaturated carboxylic acids or their amides. Particularly preferred ethylenically unsaturated structural units are acryloyl and methacryloyl groups such as acrylamido and methacrylamido and in particular acryloxy and methacryloxy. Radiation curable in the sense of the invention means that the primer composition induced by electromagnetic radiation of a suitable wavelength, such as ultraviolet radiation or electron beams, can be at least partially polymerized.

The use of radiation curable primers based on urethane acrylates allows in a particularly advantageous manner an application of the decor immediately subsequent to the application and the radiation induced curing of the primer layer, for example, by means of a digital printing technique. Herein, the primer layer provides for a good adhesion of the applied decor onto the carrier surface coated with the primer. Herein, urethane acrylates offer the advantage of good adhesion to both the carrier material and the decorative layer, i.e. the decor paint or ink. This inter alia resides in the polymerization reactions occurring in this type of polymers, in which on the one hand a radiation induced radical polymerization of the OH groups occurs and on the other hand post curing of the polymer via the NCO groups occurs. Thus, after the radiation induced curing immediately a tack-free and further processable surface is obtained, while the final properties of the primer layer are also influenced by the post-curing process based on the NCO groups and provide for a secure bond to the carrier material. In addition, the occurring post-curing process ensures that a sufficient layer stability is achieved even in less or non-exposed areas of the carrier. Thus the method according to the invention enables in particular also pre-structured carriers, i.e. carriers whose surface already have a three-dimensional structure, to be provided reliably with a primer layer, thereby ensuring that the subsequently applied decor firmly adheres to the carrier.

In the method according to the invention the primer can advantageously be applied onto the carrier plate by means of rubber rollers, a pouring device, or by spraying. Preferably, the primer is applied in an amount between 1 g/m² and 100 g/m², preferably between 10 g/m² and 50 g/m², in particular between 20 g/m² and 40 g/m². Subsequently to the application of the primer onto the carrier surface an irradiation process by means of a radiation source of an appropriate wavelength is carried out.

According to a further embodiment a carrier can be provided on the basis of a natural material, a plastic material or a wood plastic composite (WPC) material. The material of the carrier plate can—depending on the desired physical properties of the finished plate—be massive dense or comprise more or less large cavities, for example be foamed or comprise cavities the size of which is in the order of the plate dimensions. Even laminate structures of several of said materials can be used, for example plasterboard or wood plastic laminate boards.

For example, the carrier plate can be formed from a thermoplastic, elastomeric or duroplastic plastic material. Even plates made of minerals such as natural and synthetic stone plates, concrete plates, plaster fiber boards, so-called WPC boards (made from a mixture of plastic and wood) as well as plates made of natural raw materials such as cork and wood can be used as carriers according to the invention. Even plates made of biomass such as straw, maize straw, bamboo, leaves, algae extracts, hemp or oil palm fibers can be used according to the invention. Moreover, recycling materials from said materials can be used in the context of the method according to the invention. In addition, the plates can be configured based on the natural material cellulose such as paper or cardboard.

Preferred plate materials are thermoplastic plastic materials, such as polyvinyl chloride, polyolefins (for example polyethylene (PE), polypropylene (PP), polyamide (PA)), polyurethane (PU), polystyrene (PS), acrylonitrile-butadiene-styrene (ABS), polymethyl methacrylate (PMMA), polycarbonate (PC), polyethylene terephthalate (PET), polyether ether ketone (PEEK) or mixtures or co-polymerizates thereof. The plastic materials can comprise common fillers such as calcium carbonate (chalk), aluminum oxide, silicagel, quartz powder, wood flour, gypsum. They also can be coloured in a known manner. In particular, it can be provided that the plate material comprises a flame retardant.

In particular, thermoplastic plastic materials offer the advantage that the products made from them can be recycled in a very simple way. Recycling materials from other sources can be used, too. This provides for a further possibility for a reduction of the manufacturing costs.

According to a further embodiment the plate-shaped carrier can be treated with a device for reducing the electrostatic charge prior and/or during process step b).

By providing a device for reducing the electrostatic charge such as a device for discharging electrostatic charges from the carriers to be printed the occurrence of blurring in the course of the production process can be avoided. This is in particular suitable for printing processes for applying the decorative layers, because electrostatic charges which build up in the carriers to be printed in the course of the production process result in a deflection of paint or ink droplets on their way from the print head to the surface to be printed. Herein, it is assumed that the electrostatic field which builds up on the carriers deflects the paint or ink particles which are typically positively charged, such that these do not impinge on the intended point of the surface to be printed. The thus induced inaccuracy of the paint or ink application leads to a perceivable blurring of the printed image. Dependent on the production speed and the selected carrier material this effect occurs to a different degree such that it is assumed that the carrier dependent on the carrier material is charged electrostatically during the transport within the manufacturing plant and this charge is sufficient to induce the observed effect.

Herein the device for discharging electrostatic charges may at least be a roller, a brush or a lip of a conductive material having a conductivity ≧1·10³ Sm⁻¹, which electrically conductive contacts the carrier at least in the region of the printing mechanism and which is connected to an electrical ground potential. In this case, the electrical ground potential may be provided, for example, by a grounding.

According to a further embodiment of the method it may be provided that at least part of the process steps are carried out under an inert gas atmosphere. In particular, it may be provided that the process step of applying the decor or the plurality of decorative layers is performed under an inert gas atmosphere. Suitable inert gases are, for example, nitrogen, carbon dioxide, noble gases or mixtures thereof.

Here, in producing the wall or floor panel a profile can be produced at least in an edge region of the the plate-shaped carrier and the decor can be applied on the profile, too. In profiling in the sense of the invention it is provided, that by means of suitable machining tools at least in a part of the edges of the decorative panel a decorative and/or functional profile is produced. Herein, a functional profile means, for example, the production of a groove and/or tongue profile within an edge in order to allow decorative panels to be connected to each other by means of the produced profiles. A decorative profile in the sense of the invention, for example, is a chamfer formed at the edge region of the decorative panel, for example, in order to simulate a joint between two interconnected panels, such as for example in so-called wide planks.

By partially profiling the decorative panel not all profiles to be provided in the finished panel are produced, but only part of the profiles, while other profiles are produced in a subsequent step. Thus, it may be provided, for example, that the decorative profile to be provided in a panel, such as a chamfer, is produced in one step, while the functional profile, e.g. groove/tongue, is produced in a subsequent step.

By means of the application of the decor subsequently to the at least partially profiling of the carrier, for example, by means of the above-described methods, such as direct printing, abrasion or damage of the decor in the course of the profiling process can be avoided in an advantageous way. Thus, the decor also in the regions of the profile corresponds in detail to the desired imitation, for example, of a natural material.

In order to provide a particular detailed imitation even in the profiled regions the master used for the printing process can be distortion corrected in the region of the profile of the panel. Distortion correction in the sense of the invention means, for example, with respect to the exemplary case of application by means of a printing process, that the distortion of the printed image caused by the deviation of the profiling out of the surface plane of the carrier, for example, at a chamfer edge, is corrected by matching the master with the deviation. Herein, it may be provided, for example, that the correction of the distortion is implemented by matching the pixel spacing, the pixel size and/or the ink application depending on the intended edge profile of the finished decorative panel. Herein, in case of printing by means of digital printing the print head can be driven depending on the distortion to be corrected, such that the print head, for example, is deflected beyond the profiled region and the ink discharge is adapted to the profile.

Here, it is e.g. possible that prior to the application of the decorative layer of the carrier provided as a large plate, the joints (such as V-joints) to be provided in the final panel laminate, are milled into the carrier, on the thus profiled carrier at least the decorative layer is applied and subsequently the carrier is cut at least in the profiled areas. Herein, depending on the cutting method, such as sawing, laser or water jet cutting, it may be preferred that the required bleed allowance is taken into account in the produced profile.

Moreover, an additional profiling step can be carried out at least in a portion of the edges of the decorative panel substantially parallel to the surface of the panel. Hereby, for example, the functional profiles to be provided, such as groove and tongue, can be produced in the panel, whereby, for example, a mechanic locking, such as a hook lock, of individual panels with respect to each other is possible. In the case of providing the carrier as a large plate such an additional profiling step is preferably implemented after the separation into individual panels. If the carrier is already provided in the desired size of the individual panel, such an additional profiling step may also be implemented simultaneously with the formation of the other profiles, such as a chamfer.

Moreover, the invention relates to a panel embossing device comprising a supply means for a plate-shaped carrier to be embossed which comprises a decor and a top layer applied to the decor, and an embossing means for embossing a structure imitating a decorative template into the top layer, characterized in that the embossing means comprises an embossing surface formed template identical on the basis of provided three-dimensional decor data. For example, the embossing means can be an embossing roller.

Such an arrangement is in a particular advantageous manner suitable to carry out a method configured as described above in order to produce a decorated template identical wall or floor panel.

The invention is explained in detail below with reference to the figures and an exemplary embodiment.

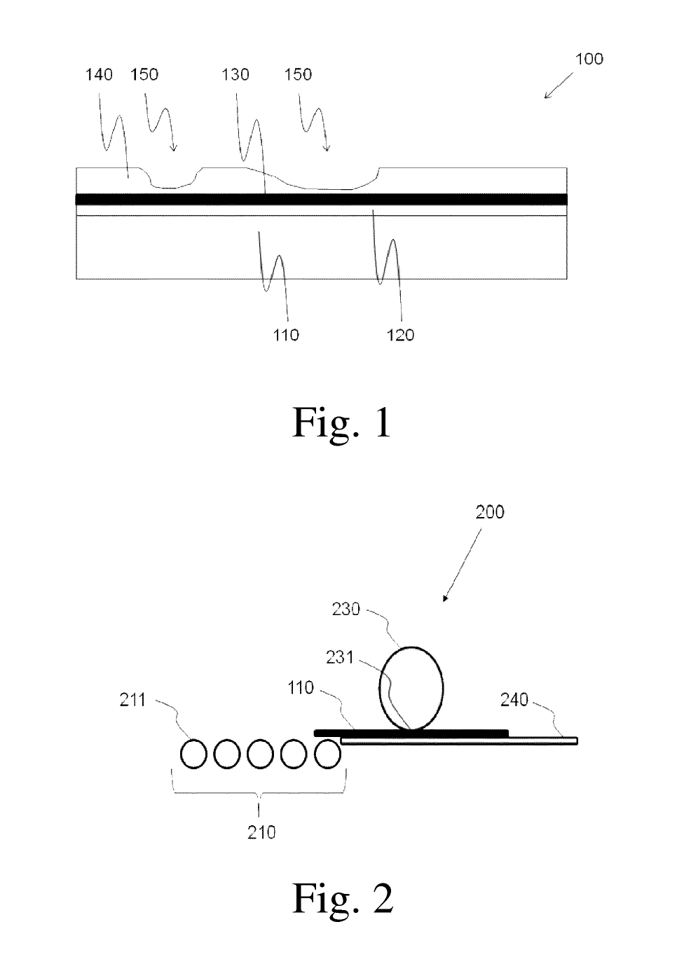

FIG. 1 shows a wall or floor panel 100 produced according to a method according to the invention. The panel 100 comprises a plate-shaped carrier 110. The carrier 110 comprises or consists of e.g. a material based on a natural material, a plastic material or a wood plastic composite (WPC) material. For example, the carrier 110 is produced from an extruded plastic material such as polyethylene (PE), polypropylene (PP), polyamide (PA), polyurethane (PU), polystyrene (PS), acrylonitrile-butadiene-styrene (ABS), polymethyl methacrylate (PMMA), polycarbonate (PC), polyethylene terephthalate (PET), polyether ether ketone (PEEK) or mixtures or co-polymerizates thereof.

Onto the carrier 110 a layer 120 comprising a primer may be applied, which in particular includes a radiation cured polyurethane acrylate or polyurethane. Onto the primer, moreover, a decor 130 is applied for example by means of suitable printing techniques such as screen printing, digital printing, flexographic or offset printing, or by laminating. In order to imitate a decorative template by the decor 130 not only with respect to the color but also structurally and to further protect the wall or floor panel 100 a top layer 140 is applied onto the decor 130. The top layer 140 is provided with a template identical structure for example by forming pores 150. Thus, a natural wood material can be imitated by forming structures three-dimensionally template identical not only with respect to the width or length but also with respect to the depth or depth distribution. Further, the wall or floor panel 100 and its plate-shaped carrier 110 may include a profile at least in an edge region, and the decor 130 can be applied onto the profile, too. Herein, the top layer 140 may be applied in multiple layers and can comprise a structural layer and a protective layer and/or be at least partially formed from a radiation curable composition.

FIG. 2 shows a panel embossing device 200 for introducing such a structure into the top layer 140. The device 200 comprises a supply means 210, for example comprising discharging means 211, for example rolls or rollers for a plate-shaped carrier 110 to be embossed, by means of which the carrier 110 is supplied to an embossing means 230, such as an embossing roller. The embossing means 230 comprises an embossing surface 231 which may be formed for example of a plastic material, such as rubber. As apparent from the foregoing the plate-shaped carrier 110 has already passed through a printing unit for applying a decor 130 and a means for applying a top layer 140 before it is supplied to the embossing means 130, wherein the plate-shaped carrier 110 before and/or during application of the decor by printing may have been treated by a device for reducing the electrostatic charge.

If the carrier 110 has been supplied to the embossing means 230 the carrier 110 may be arranged on a support 240 or between a support 240 and the embossing means 230. Here, the embossing means 230 comprises an embossing surface formed template identical on the basis of provided three-dimensionally decor data derived, for example, by three-dimensionally scanning a decorative by use of, for example, electromagnetic radiation. The embossing means 230 or the embossing surface 231 may comprise a plastic material which is formed by laser scribing and subsequent electroplating. In order to achieve a particularly identical result, moreover, a mark may be introduced into the decor 130 by means of which the embossing means 230 can be aligned relative to the decor 130.

1. Method for producing a decorated wall or floor panel comprising the process steps:
a) providing a plate-shaped carrier;
b) applying a decor imitating a decorative template onto at least a portion of the plate-shaped carrier; and
c) applying a top layer onto at least a portion of the decor;
wherein the top layer is provided with a template identical structure simulating the applied decor by embossing with an embossing surface which is formed on the basis of provided three-dimensional decor data.

2. Method according to claim 1, wherein the embossing surface is on an embossing roller.

3. Method according to claim 1, wherein the embossing surface is formed by use of electromagnetic radiation.

4. Method according to claim 1 wherein the embossing surface comprises a plastic material which is formed by laser structuring and subsequent electroplating.

5. Method according to claim 1, wherein the top layer is applied in multiple layers.

6. Method according to claim 1, wherein the top layer is at least partially formed of a radiation curable composition.

7. Method according to claim 1, wherein a mark is introduced within the decor based on which the embossing surface can be aligned relative to the decor.

8. Method according to claim 1, wherein the three-dimensional decor data are provided by three-dimensionally scanning the decorative template.

9. Method according to claim 1, wherein the decor is applied by direct printing or laminating.

10. Method according to claim 1, wherein the decor is applied onto at least a portion of a previously applied primer.

11. Method according to claim 1, wherein the carrier comprises a natural material, a plastic material or a wood plastic composite material (WPC).

12. Method according to claim 11, wherein the carrier comprises a thermoplastic plastic selected from the group consisting of polyvinyl chloride, polyolefine (such as polyethylene (PE), polypropylene (PP), polyamide (PA), polyurethane (PU), polystyrene (PS), acrylonitril butadiene styrene (ABS), polymethyl methacrylate (PMMA), polycarbonate (PC), polyethylene terephthalate (PET), polyether ether ketone (PEEK) or mixtures or co-polymerizates thereof.

13. Method according to claim 1, wherein the plate-shaped carrier is treated by a device for reducing the electrostatic charge prior and/or during to process step b).

14. Method according to claim 1, wherein a profile is introduced into the plate-shaped carrier at least in an edge region.

15. Panel embossing device comprising
a feeder for a plate-shaped carrier to be embossed, wherein the plate-shaped carrier comprises a decor and a top layer applied onto the decor; and
an embossing surface for embossing a structure imitating a decorative template into the top layer;
characterized in that
the embossing surface is formed template identical on the basis of provided three-dimensional decor data.
